(19) United States
(12) Patent Application Publication
(10) Pub. No.: US 2013/0174075 A1
(43) Pub. Date: Jul. 4, 2013

(54) METHOD FOR ACQUIRING PROGRAM PARAMETERS OF COMPONENT IN GRAPHICAL USER INTERFACE OF EQUIPMENT AND METHOD FOR OPERATING EQUIPMENT

(71) Applicants: Min-Hao Li, Guishan Township (TW); Tsai-Hsu Lin, Zhongli City (TW); Ta-Chih Hung, Zhubei City (TW); Cheng-Tso Tsai, Kaohsiung City (TW); Chi-Pin Chen, Hsinchu City (TW); Cheng-Chen Yang, Hsinchu City (TW)

(72) Inventors: Min-Hao Li, Guishan Township (TW); Tsai-Hsu Lin, Zhongli City (TW); Ta-Chih Hung, Zhubei City (TW); Cheng-Tso Tsai, Kaohsiung City (TW); Chi-Pin Chen, Hsinchu City (TW); Cheng-Chen Yang, Hsinchu City (TW)

(73) Assignee: INDUSTRIAL TECHNOLOGY RESEARCH INSTITUTE, HSINCHU (TW)

(21) Appl. No.: 13/612,697

(22) Filed: Sep. 12, 2012

(30) Foreign Application Priority Data
Dec. 30, 2011 (TW) 100150006

(51) Int. Cl. G06F 3/048

(52) U.S. Cl. 715/771

(57) ABSTRACT

A method for acquiring program parameters of a component in a graphical user interface of a piece of equipment and an operating method for a piece of equipment are provided. The method for acquiring program parameters of a component includes: detecting a selection of a component in a graphical user interface window, obtaining a first data set for searching the selected component, presenting the first data along with corresponding indications on a window frame to obtain an approved second data set, and storing the approved data set to a resource file. The method for operating a piece of equipment includes: reading a resource file, searching a window handle of a component described in the file in a graphical user interface window, performing a data read operation or a user operation by using the window handle and a corresponding parameter template in response to a request message.

This application claims the benefit of Taiwan application Serial No. 100150006, filed Dec. 30, 2011, the disclosure of which is incorporated by reference herein in its entirety.

### TECHNICAL FIELD

The disclosure relates in general to a method for acquiring program parameters of a component in a graphical user interface (GUI) window of a piece of equipment and a method for operating a piece of equipment.

### BACKGROUND

In many factories, e.g., semiconductor manufacturers, the equipment in service adopt window-based graphical user interface (GUI). Programs of most pieces of equipment are closed system and do not flexibly support extended hardware functions. Thus, it is difficult to communicate or integrate such pieces of equipment with new-generation, state-of-the-art equipment.

Despite of the above complications, data, statuses and controls of these pieces of equipment have to be integrated to a Computer Integration Manufacturing (CIM) system in the factories. In a conventional approach, program parameters of a GUI of the above equipment are manually collected by software developers by utilizing hooking tools, so as to acquire the program parameters of host software GUI of the equipment. However, the manual collection for the program parameters are quite time consuming. Since production lines are frequently fully loaded and the related equipment cannot be halted, suspensions resulted by program parameter collections may severely affect production capacity.

Moreover, uncertainty may exist in the collected program parameters, meaning that the program parameters may change in a next execution or after a few executions of the program. For the programming of a dedicated program regarding this, the collected program parameters are commonly referred in a hard-coded manner. In the event that the uncertainty of a particular software parameter is unfound, the program may become faulty such that the program would be rewritten or modified by program staff repeatedly re-collecting the program parameters or iterating tests. Consequently, a suspension period of the equipment may be increased. To the worst case, it would lead to erroneous analysis or control results. Further, the time needed for the manual comparison process may be exponentially increased as the number of the target program parameters gets larger.

A factory may have hundreds types of equipment, each of which may cost millions of dollars. A complete halt of the equipment is rather an ultimate option. Therefore, there is a need for a solution for extending functions of existing equipment.

### SUMMARY

The disclosure is directed to a method for acquiring program parameters of a component in a graphical user interface (GUI) window of a piece of equipment and an operating method for a piece of equipment.

According to one embodiment, a method for acquiring program parameters of a component in a GUI window of a piece of equipment is provided. The method includes the following steps. A selection of the component in the graphical user interface of the piece of equipment is detected by a processing unit of the piece of equipment. A first data set for searching the selected component is obtained by the processing unit. The first data set and a plurality of indications corresponding to the first data set is presented on a window frame by a display unit of the piece of equipment to obtain an approved second data set. The approved second data set is stored to a resource file in a memory unit of the piece of equipment in response to an acceptance operation. The resource file includes at least one storage data set, which is for positioning an associated component in the graphical user interface window of the piece of equipment and for defining a corresponding operation to be performed on the associated component. The at least one storage data set includes the approved second data set.

According to another embodiment, an operating method for a piece of equipment is provided. The method includes the following steps. A resource file is provided in a memory unit of the piece of equipment, wherein the resource file for positioning an associated component in a GUI window of the piece of equipment and for defining a corresponding operation to be performed on the associated component. The resource file is read from the memory unit by a processing unit of the piece of equipment. A window handle of the associated component corresponding to each of the at least one storage data set of the resource file is obtained by the processing unit from a graphical user interface of the piece of equipment. In response to a request message indicative of executing an operation on an associated component corresponding to the obtained at least one window handle, a parameter template corresponding to the window handle is selected by the processing unit. The corresponding operation is performed, by the processing unit, on the associated component according to the window handle and the parameter template.

The above corresponding operation may be a data read operation or a user operation.

### BRIEF DESCRIPTION OF THE DRAWINGS

FIG. 1 shows an architecture for extending communication functionality of a piece of equipment according to one embodiment.

FIG. 2 is an image of a program executed in a GUI window of a piece of equipment.

FIG. 3 is a schematic diagram of software implementation in a front end according to the embodiment in FIG. 1.

FIG. 4 is a schematic diagram of software implementation in a back end according to the embodiment in FIG. 1.

FIG. 5 is a flowchart of a method for acquiring program parameters of a component in a GUI window of a piece of equipment according to one embodiment.

FIG. 6 is a schematic diagram of step 130 of the embodiment in FIG. 5 performed by a program.

FIG. 7 is an example of a child window generated in an operation process of the image of the program in FIG. 2.

FIG. 8 is a tree diagram illustrating relationships among window components in a program executed by a GUI window of a piece of equipment.

FIG. 9 is a schematic diagram of a format of a resource file according to one embodiment.

FIG. 10 is a flowchart of a method for operating a piece of equipment according to one embodiment.

FIG. 11 is a flowchart of step S230 in the embodiment in FIG. 10 as a method for obtaining window handles of non-enumerable components according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments related to a method for acquiring program parameters of components in a graphical user interface (GUI) window of a piece of equipment and an operating method for a piece of equipment. In one embodiment, the operating method for a piece of equipment is capable of extending communication functionality of the piece of equipment through a resource file, so that the piece of equipment is enabled to receive a request message and perform a corresponding operation, e.g., a data read operation or a user operation. In one embodiment, the operating method for a piece of equipment further achieves remote monitoring.

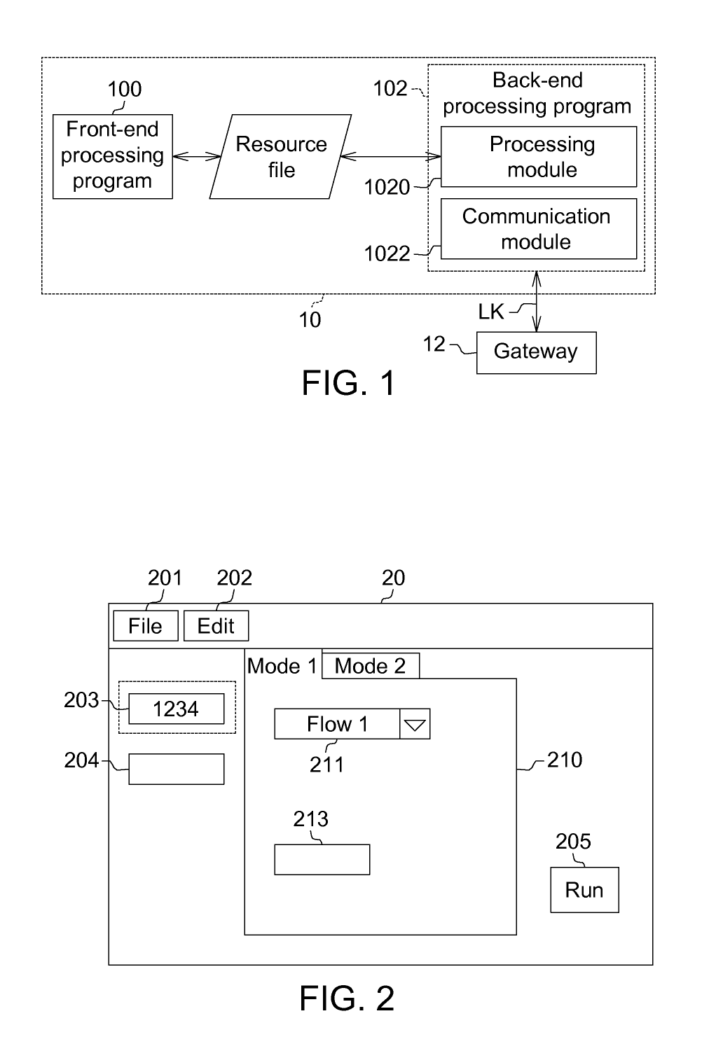

FIG. 1 shows an architecture for extending communication functionality of a piece of equipment according to one embodiment. For example, a piece of equipment 10 is exemplified as a piece of production equipment or manufacturing equipment for use in a factory, such as a piece of semiconductor manufacturing equipment. The piece of equipment 10 may include machine and electrical apparatuses for its intended purpose, such as for semiconductor manufacturing. In addition, the piece of equipment 10 further includes a computer system or an embedded system that provides a human-machine-interface (HMI), which may include, e.g., a processing unit (such as a microcontroller, or one or more processors), a memory unit, a display unit (such as LCD panel or touch panel), and a communication module (e.g., for serial communication, or networking such as LAN or other kind of network). The computer system or the embedded system employs an operating system with a GUI window, e.g., Windows or UNIX-based operating system or other embedded operating system. The operating system executes an application program, e.g., a GUI 20 of an application program shown in FIG. 2 for monitoring and controlling operations of the piece of equipment, for example. That is to say, the GUI 20 of the application program outputs operation parameters (e.g., parameters of the piece of equipment in operation such as pressure, temperature and statue values) of the program or the piece of equipment, and on the other hand allows a user to perform operations through the GUI 20. For example, the user operation indicates program setting, data input or item selection to set or change the manner of operation of the application program or the piece of equipment, e.g., to select or change a manufacturing recipe of the piece of equipment.

For example, an operating piece of semiconductor equipment needs to maintain a close communication with a host during a production process, so as to receive a control or a query from a host computer, in real-time response to a request of the host and to report an execution result and actively report abnormalities in the piece of equipment. Referring to FIG. 1, the architecture for extending communication functionality of a piece of equipment includes a front-end processing program 100 and a back-end processing program 102. In the front-end processing, according to various requirements for back-end application, a user can employ the front-end processing program 100 to acquire a plurality of data sets of components which correspond to the outputting of operation parameters and the execution of user operations in the GUI 20 of an application program, so as to generate a resource file. The data sets indicate content (or description) for obtaining window handles corresponding to components in the back-end processing.

In the back-end processing, the window handles of the components indicated by the resource file are obtained from the GUI 20 of the operating application program by executing the back-end processing program 102. In addition, through a communication link LK, the piece of equipment 10 can be connected to an external computing device, e.g., a gateway 12. Referring to FIG. 4, the gateway 12 has a communication interface for the communication link LK, e.g., TCP/IP, Semiconductor Equipment Communication Standard (SEMI) or other communication protocols, so as to serve as a communication medium between the piece of equipment 10 and another system. For example, the gateway 12 includes a processor 120 and a communication unit 121. The communication unit 121 provides a communication interface. Therefore, through the back-end processing program 102, the piece of equipment 10 is allowed to acquire an operation parameter from the application program of the piece of equipment 10 and output the operation parameter to the gateway 12 in response to a data read request (such as request message RQ1 or RQ2), and is also enabled to perform a user operation on the application program of the piece of equipment 10 in response to a user operation request sent by the gateway 12. Under such architecture, other back-end processing, e.g., an automated monitoring program in the gateway 12 or integration to the CIM system of the factory, can be implemented, thereby extending the communication and auto-control functionalities of the piece of equipment 10. For example, SECS and SVID message streams are implemented as a communication means between the piece of equipment 10 and the gateway 12, for example, under the condition that the application program 200 is in a closed system that does not support SECS.

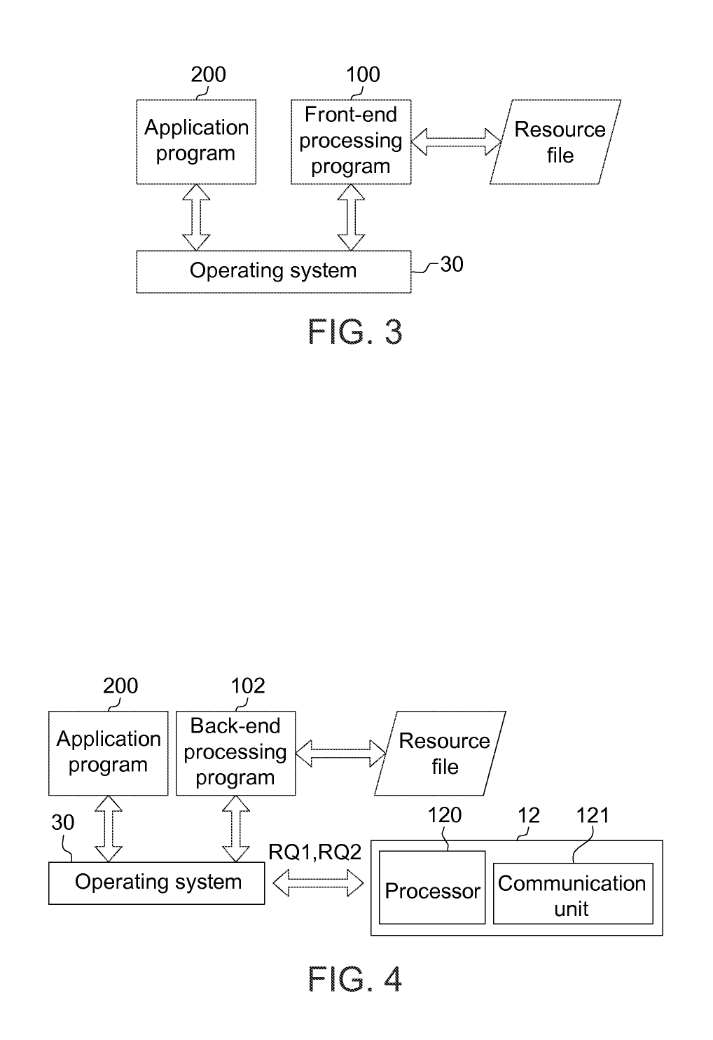

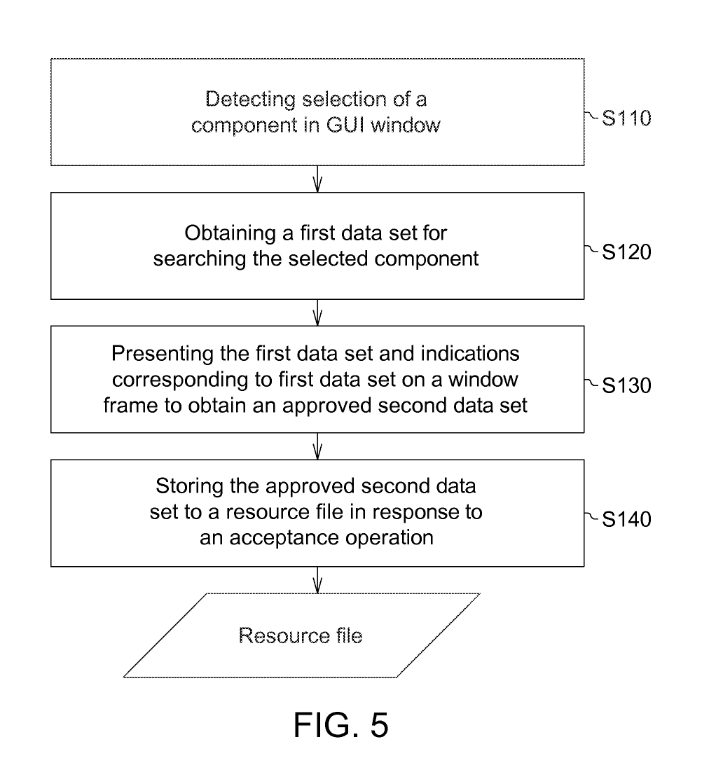

FIG. 3 shows a schematic diagram of software implementation in the front-end processing according to the embodiment in FIG. 1. In FIG. 3, when an operating system 30 of the piece of equipment 10 executes the application program 200, the front-end application program 100 (or implemented as software formed by multiple program modules) is executed. Accordingly, by use of the front-end processing program 100, a user can select a GUI component of the GUI 20 of the application program 200 and follows the corresponding operations of the GUI of the front-end processing program 100 so as to generate a resource file. The front-end processing program 100 implements a method for acquiring program parameters of a component in a GUI window of a piece of equipment. FIG. 5 shows a flowchart of a method for acquiring program parameters of a component in a GUI window of a piece of equipment according to one embodiment. Referring to FIG. 5, in step S110, a selection of a component in the GUI window of the piece of equipment 10 is detected by a processing unit of the piece of equipment 10. For example, as shown in FIG. 2, the front-end processing program 100 allows a user to make a selection, such as by clicking or a rectangular selection or any way of selection, of any GUI component in the GUI 20 of the application program 200 through a mouse, touch control or other input devices. For example, these components may be a pull-down menu 201 and 202, an output text frame 203, an input text frame 204 and a button 213 in the main window, or a component in a tabbed page 210 of the main window, e.g., a drop-down menu 211 or a button 213.

In step S120, a first data set for searching the selected component is obtained, e.g., by the processing unit of the piece of equipment 10. For example, the first data set includes a first window class, first relative coordinates and a first size corresponding to the selected component, and a second window class, second relative coordinates and a second size corresponding to a parent component of the selected component. For example, after a user selects the output text frame 203 (as shown by a dotted frame in FIG. 2), the front-end program 100 regards the selected output text frame 203 as a target component. The front-end program 100 thus obtains a first data set of the target component, i.e., a window handle of the target component and related window parameters. Taking a Windows system as the operating system 30 for example, a Win32 application program interface (API) of the Windows system provides several APIs: GetCursorPos( ), WindowFromPoint( ), GetWindow( ), EnumChildWindows( ) and GetParent( ) which can be used to acquire the handle and related parameters. When the front-end processing program 100 performs step S120, the window handle of a component corresponding to a position of a mouse cursor (or a selected range) is obtained by the processing unit of the piece of equipment 10 through the API(s) provided by the operating system 30, and other program parameters are further obtained, such as, class name, coordinates, a size and a title of the component, and program parameters of a process path.

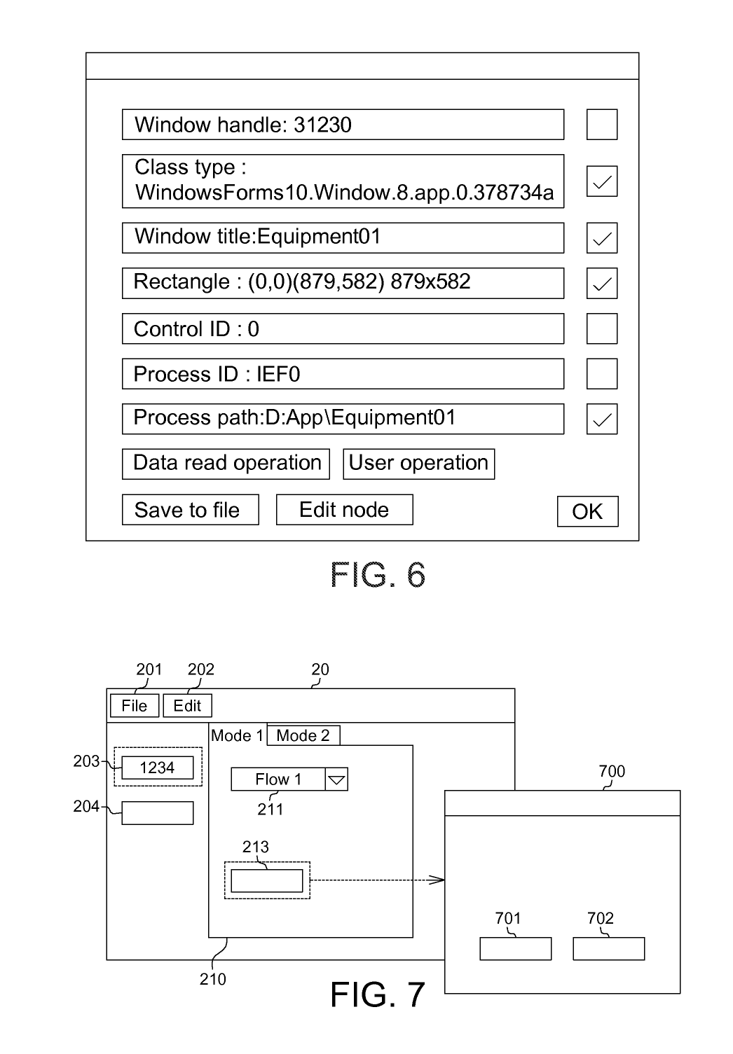

In step S130, the first data set and a plurality of indications corresponding to the first data set are presented on a window frame, by a display unit of the piece of equipment 10, to obtain an approved second data set. For example, FIG. 6 shows a schematic diagram of the front-end processing program 100 implementing step S130. In FIG. 6, the front-end processing program 100 enumerates the results of acquiring program parameters of a selected component, e.g., component in a child window. A window frame, as illustrated in FIG. 6, presents the program parameters, each having a checkbox at the right. The appropriate parameters are checked as indications for informing the user that the checked parameters are suggested items selected as a default setting and can be served as program parameters for obtaining a window handle of the same component in the back-end processing. Further, the user is allowed to set a corresponding operation to be performed on the component corresponding to the current data set. For example, buttons corresponding to “data read operation” and “user operation” in FIG. 6 may be pressed for setting. With a confirmation of the user, a button of “save file” can be pressed to save the accepted program parameter items to the resource file to obtain an approved data set. The program parameter items may be selected as the user sees appropriate. Further, a button of “edit” may be provided in the window frame for allowing the user with manual input or modification. It should be noted that, the details above are exemplary examples, and a person skilled in the related art can appreciate that approaches for performing step S130 of presenting the data set are not limited to the details above.

In step S140, in response to an acceptance operation (e.g., when the button for “save file” or “OK” in FIG. 6 is pressed or other operation commands), the approved second data set is saved to the resource file in a memory unit of the piece of equipment 10, wherein the second data set is the selected program parameters that are approved and stored to the resource file. The second data set saved to the resource file in step S140 is commonly referred to as a storage data set. The resource file includes at least one storage data set. The at least one storage data set is for positioning an associated component in the GUI window of the piece of equipment and for defining a corresponding operation to be performed, by the processing unit of the piece of equipment 10, on the associated component, i.e., the data read operation or the user operation. The at least one storage data set includes the approved second data set. For example, in the resource file, the corresponding operation is indicated as “output” for the “data read operation” and indicated as “input” for the “user operation”. It should be noted that such indications with “input” and “output” are merely an exemplified way of naming with respect to the application program of the piece of equipment, and other ways of naming can be used in implementation, not limiting to the above. Following the above example, the storage data set corresponding to the output operation is referred to as an output data set, and the storage set corresponding to the input operation is referred to as an input data set. The resource file possibly includes at least one output data set, at least one input data set, or both types of data sets. Referring to FIG. 9, in an alternative embodiment, for example, the resource file includes an input part and an output part, as presented in a structural form such as a structural markup language, e.g., Extended Markup Language (XML). The output part represents at least one output data set for positioning an associated component, from which data can be read. The input part represents at least one data set for positioning an associated component, on which a user operation can be performed. For example, the user operation indicates a data input action (e.g., inputting via the input text frame 204 in FIG. 2) or an operation of a cursor selection or cursor control such as a selection from a menu (e.g., selecting an item for a manufacturing recipe in the drop-down menu 211 in FIG. 2) or pressing a button (e.g., the button 205 in FIG. 2). Further, steps S110 to S140 in the above method may be iterated to allow a user to continue acquiring the program parameters of another component. As will be illustrated later, the operations indicated in the resource file is to be performed by the processing unit of the piece of equipment 10 during the back-end processing in response to a corresponding request.

Thus, the front-end processing program 100 implemented according to steps S120 and S130 can be regarded as having filtering functionality. That is, the program parameters corresponding to the selected component are enumerated, and the program parameters recommended by expert knowledge are indicated and presented in the window. The above approach is according to expert knowledge. In order for the back-end processing to correctly find, by the processing unit of the piece of equipment 10, the window handles of the components selected in the front-end processing, a criterion with a plurality of program parameters are required for determination of the correctness of the found handles, wherein the program parameters include such as a class name, coordinates and a size of the component and the data set of the parent component(s). Therefore, in step S130, according to expert knowledge, appropriate indications are given to assist the user in determining which of the program parameters are to be utilized as the data set for describing the selected component.

Examples of the filtering functionality according to expert knowledge shall be given below. For example, the window handle of a component can be obtained and employed for controlling the component in the window system, and any two window handles occurred at the same time will not have a same value. However, during different stage, such as, after rebooting or re-execution of the application program, a same component may have different window handles. Therefore, as shown in step S130 according to one embodiment in FIG. 6, the selection of the window handle is not recommended, whereas the selection of program parameters that do not change due to rebooting or re-execution of the application program is recommended.

In an actual application program, there is a main window and a child window of the main window. In the main window or the child window, different window components may exist. For example, a new form or a new dialog box may be triggered by pressing a button, and the data or a message presented in the newly generated window may be data that the user needs to capture and utilize, e.g., operation data (e.g., pressures and temperatures) of the piece of equipment. In view of the above different situations of generating windows, the window components may be categorized into enumerable window components and non-enumerable window components.

Enumerable window components are, for example, the main frame 20 in the application program 200, and the components 201, 202 and 203 in the main frame 20. The window handles of these components are present and do not change throughout the execution of the application program 200, and are enumerable by the API provided by the operating system 30. In step S130 according to one embodiment, the indications in FIG. 6 may be provided according to expert knowledge to provide “class name,” “window title,” “coordinates and size” and “processing path” as basic settings. Under normal circumstances, “class name” and “coordinates” of the selected component and other parent component(s) can be employed for correctly describing the selected component.

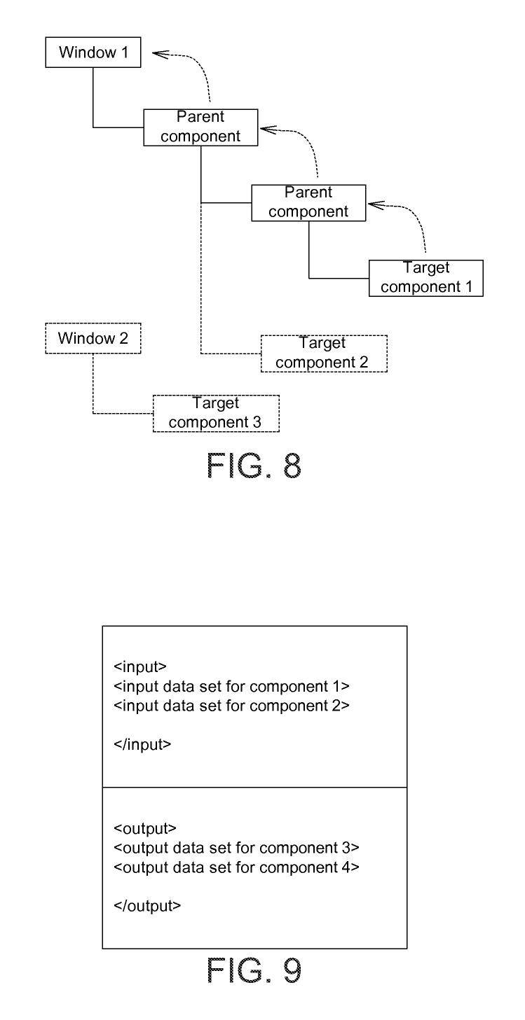

Further, enumerable components may be established on multi-layer window components, as shown by a combo box 211 in FIG. 2. In one embodiment, the data set of the component is enumerated by a “from-bottom-to-top” approach. That is to say, after the program parameters of the component are obtained by the processing unit of the piece of equipment 10, program parameters of a parent node (i.e., a parent component) and those of a one-layer-up parent component are then obtained. Accordingly, the program parameters of a root node (i.e., the main window) are obtained. These program parameters can thus serve as conditions for obtaining the window handle of the selected component in the back-end processing. FIG. 8 shows a tree diagram illustrating relationships among the window components. As shown in FIG. 8, when a component (e.g., a target component 1) is selected by a user through the front-end processing program 100, besides acquiring the program parameters of the target component 1, the front-end processing program 100 also acquires the program parameters of the parent components upwards until the program parameters of the window 1 are acquired. Taking the combo box 211 in FIG. 2 for example, the data set in Table 1 is obtained, or obtained through filtering, for describing the target component.

TABLE 1
hwnd1301
< Parent=10706, hWnd_Target=1070c , ClassName=TComboBox, Title=, RECT= (−89, −56 )
201×21 >
< Parent=10704, hWnd_Target=10706 , ClassName=TPanel , Tltle=, RECT= ( 0, 0) 381×310
>
< Parent=106e6, hWnd_Target=10704 , ClassName= TTabsheet, Title= Single process
mode, RECT= (−4, −27 ) 381×310 >
< Parent=106de, hWnd_Target=106e6, ClassName=TPageControl, Title, RECT= (−188, 0 )
389×341 >
< Parent=106dc, hWnd_Target=106de , ClassName=TPanel, Title=, RECT= (−14 ,−61 )
577×399 >
< Parent=10198, hWnd_Target=106dc, ClassName=TFenRunProc, Title = Process Run,
RECT= (4, 23), 811×470 >
< Parent=10196, hWnd_Target=10198, ClassName=MDIClient, Title=, RECT= (0, −69 )
803×443 >
< Parent=3002c, hWnd_Target=10196, ClassName=TFprinci, Title=G. U. I Alcatel AMS200 -
[Process Run], RECT= (400, 300) 803×601 >
< Root > < Parent=0, hWnd_Target=3002c, ClassName=TApplication, Title=G. U. I Alcatel
AMS200, RECT= (400, 300) 0×0 >

In the above data set, “hwnd1301” in the first row is an alias of the data set, which can be user-defined or set by the front-end processing program 100. Symbols between the smaller-than symbol (<) and the greater-than symbol (>) describe the program parameters of the selected component. More specifically, in the second row between the symbols (<) and (>), the class name is TComboBox, the coordinates and size (e.g., RECT) are respectively (−89,−56) and 201x21, and the selected component with a current handle hWnd_Target=1070c corresponds to the parent component with a current handle Parent=106e6. In the third row, the parameters of the above parent component with a current handle hWnd_Target=106e6 are described. More specifically, in the third row, the class name is TPanel, the coordinates and size are respectively (0,0) and 381x310, the selected component with a current handle hWnd_Target=106e6 corresponds to the parent component with a current handle Parent=10704. Thus, program parameters of the root node (the application program)<Root> are obtained. In some nodes, the title is further utilized as one of the program parameters. As previously stated, since the handles do not need to be recorded, an alias may be utilized in substitution of the above handles when performing step S140, or a relationship with a parent component may be indicated through other approaches.

Non-enumerable window components are windows and components that are dynamically generated and then destroyed during the execution of the application program 200. Referring to FIG. 7, a child window 700 (i.e., a form) is generated when the button 213 is selected. The child window 700 has text frames 701 and 702 respectively presenting parameters of the piece of equipment. During the execution of the application program 200, the child window 700 and the window handles of these components only exist when the child window 700 is generated and are immediately destroyed when the child window 700 is closed. That is to say, the above components are not always existent throughout the execution of the application program 200, and are thus categorized as non-enumerable components. Regarding the above situation, a target component 2 indicated in a dotted frame in FIG. 8 illustrates the generated and destroyed window and component that are appended to a child node of the window 1 during a particular period of the execution of the window 1.

Another type of non-enumerable window components are windows and components that are independently generated and destroyed during a particular period of the execution of the window 1, as shown by a window 2 and a target component 3 indicated in dotted frames.

In the front-end processing, through user's operations with the application program 200, when the above non-enumerable window components such as the child window 700 is generated, the components are able to be selected with the foregoing “from-top-to-bottom” approach and the data set of the selected components (e.g., 701 and 702) may still be obtained. In the back-end processing, by correspondingly utilizing the data set of the non-enumerable components at an appropriate time period, the handles of the corresponding components are retrieved. Examples of the back-end processing shall be given shortly in embodiments below.

An independent and non-enumerable dialog box is taken as the window 2 in FIG. 2 as an example. By implementing the filtering functionality of steps S120 and S130 with the front-end processing program 100, the data sets of three components generated from the dialog box are as below.

TABLE 2
<root node> “Open Sequence”
window caption: Open Sequence, ClassName: TGDLG, RECT: (518,405), (952,605) 434×200
<Level101 node> (parent::Open Sequence)
(1) window caption: ListBox, ClassName: ListBox, Title: (for: Available), RECT: (−121,−60)
108×132
(2) window caption: Open, ClassName: Button, Title: (for: Open), RECT: (−231,−59) 80×22
(3) window caption: Cancel, ClassName: Button, Title: (for: Cancel), RECT: (−231,−89) 80×22

A window caption of the dialog box in this example is “Open Sequence,” and the three components are respectively a list box, open, and cancel buttons, which have respective captions ListBox, Open and Cancel. According to expert knowledge, besides the “class name” and “coordinates and size” of the component and other parent components, other fixed program parameters are also required as basis for correctly describing such type of independent and non-enumerable components. From the above data set, it is known that parent components of the three components have a caption “Open Sequence” as a distinction for determining a component of a parent window.

Further, the coordinates of the main window 20 and the child window or components of the application program 200 change as the position of the main window changes. Therefore, in one embodiment, the coordinates of the component described by the data set are expressed in relative coordinates. That is, coordinates of a particular component recorded in a data set are relative coordinates with respect to a component of a one-layer-up component (i.e., a parent component). For example, upon obtaining top-left coordinates and bottom-right coordinates of a selected component, top-left and bottom-right coordinates of the parent component of the selected component are also obtained. By subtraction, the relative coordinates and the size of selected component with respect to the parent component are obtained. For example, referring to Table 2, the top-left and bottom-right coordinates of the button “Open” described are respectively (749,464) and (829,486), and the top-left and bottom-right coordinates of the parent component are respectively (518,405) and (952,605). Thus, the relative coordinates of the selected component are (518−749,405−464)=(−231,−59), and the size is (829−749)×(486−464)=80×22. General equations for the calculation according to the embodiment are as below.

Relative coordinates:((P.left−c.left),(P.top−c.top)) Equation (1)

Size: (c.right−c.left)×(c.bottom−c.top) Equation (2)

In these equations, the coordinate system is exemplified by a general coordinate system in computer display, such as the display unit of the piece of equipment 10. The current top-left and bottom-right coordinates of the component are respectively (c.left, c.top) and (c.right, c.bottom), and the top-left coordinates of the parent component is (P.top, P.left). In the example above, the top-left coordinates of the parent component are taken as the coordinates of a reference point. In other embodiments, other point of the parent component, e.g., the bottom-right coordinates or the center point of the parent component, can be taken as a reference point for calculating the relative coordinates, not limiting to the above examples. Further, in other embodiments, when a component is expressed by two pairs of coordinates, such expression is equivalent to adopting relative coordinates.

In an alternative embodiment, during the searching of the parent component from-bottom-to-top from the target component in FIG. 8, in step S120, the corresponding program parameters can be obtained and the relative coordinates and sizes of the components can be calculated, by the processing unit of the piece of equipment 10, so as to generate the data set of the target component.

The resource file in step S140 can be described in XML, for example, as shown in Table 3.

```
TABLE 3
<?xml version=“1.0” encoding=“big5”>
<Mapping>
  <Equip_Model=“SPYTarget01” Type=“Module” exe=“D:\App\Equipment01.exe”>
    <inputs NodeLevel=“1” Parent_Caption=“Equipment01”
Parent_ClassName=“ WindowsForms10.Window.8.app.0.378734a”>
      <input AliasName=“btnStart” Type=“Button” ClassName=“
WindowsForms10.BUTTON.app.0.378734a” RECT=“(531,234),(606,257) 75×23” />
    ...
      <input AliasName=“tabControl” Type=“SysTabControl32”
ClassName=“ WindowsForms10. SysTabControl32.app.0.378734a” RECT=“” />
      <inputs NodeLevel=“2” Type=“SysTabControl32”
Parent_Caption=“load/unload” Parent_ClassName=“ WindowsForms10.
SysTabControl32.app.0.378734a”>
        <input AliasName=“btnLoad” Type=“Button” ClassName=“
WindowsForms10.BUTTON.app.0.378734a” RECT=“(131,358),(206,381) 75×23” />
        <input AliasName=“btnUnLoad” Type=“Button” ClassName=“
WindowsForms10.BUTTON.app.0.378734a” RECT=“(131,407),(206,430) 75×23” />
        <input AliasName=“” Type=“btnOpenNewForm”
ClassName=“WindowsForms10. BUTTON.app.0.378734a” RECT=“(131,465),(291,488)
160×23” />
      </inputs>
    </inputs>
    <outputs NodeLevel=“1” Parent_Caption=“Equipment01”
Parent_ClassName=“ WindowsForms10.Window.8.app.0.378734a”>
      <output AliasName=“SPMEXH_SV01” Unit=“mmH2O” Type=“EDIT”
ClassName=“WindowsForms10.EDIT.app.0.378734a” RECT=“(106,108),(471,130) 365×22”
/>
    ...
      <output AliasName=“SDSPEED_SV04” Unit=“RPM” Type=“EDIT”
ClassName=“WindowsForms10.EDIT.app.0.378734a” RECT=“(106,234),(471,256) 365×22”
/>
      <outputs NodeLevel=“2” Parent_Caption=“Equipment01”
Parent_ClassName=“ WindowsForms10.Window.app.0.378734a”>
        <output AliasName=“SPMEXH_SV05” Unit=“mmH2O”
Type=“EDIT” ClassName=“WindowsForms10.EDIT.app.0.378734a”
```

| | |
|---|---|
| RECT=“(123,353),(300,375) 177×22” /> | <output |

```
AliasName=“SPMEXH_SV06” Unit=“mmH2O” Type=“EDIT”
ClassName=“WindowsForms10.EDIT.app.0.378734a” RECT=“(123,394),(300,416) 177×22”
/>
      </outputs>
    </outputs>
  </Equip>
</Mapping>
```

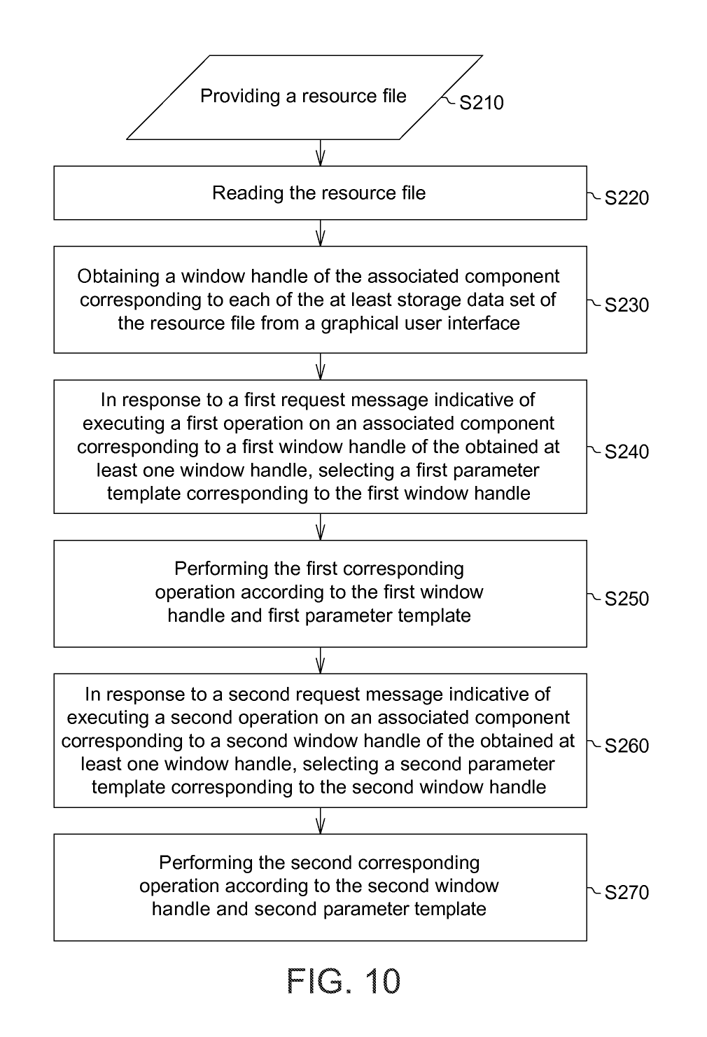

FIG. 10 shows a flowchart of a method for operating a piece of equipment. FIG. 4 shows a schematic diagram of the back-end processing program 102 (formed by one or several software modules) implementing the method in FIG. 10. The method for operating a piece of equipment is performed by referring to a structural resource file. As shown in FIG. 10, in step S210, a resource file is provided, e.g., in a memory unit of the piece of equipment. For example, the resource file is realized in different formats, e.g., as a mapping table. The resource file includes the abovementioned at least one storage data set. The resource file possibly includes at least one output data set, at least one input data set, or both types of data sets. The resource file according to one embodiment includes two parts—an input description and an output description. The output description includes at least one output data set for positioning an associated component, from which data can be read by a processing unit of the piece of equipment, such as the description in <outputs></outputs> in Table 3. The input description includes at least one input data set for positioning an associated component, on which a user operation can be performed by the processing unit of the piece of equipment, such as the description in <inputs></inputs> in Table 3. For example, the user operation indicates a data input action, a cursor selection action or a cursor control action, i.e., a common user operation through a keyboard, a mouse or touch control. For example, the data sets include a first window class, first relative coordinates and a first size corresponding to the associated component, as well as a second window class, second relative coordinates and a second size of one or more parent components of the associated component.

In step S220, the resource file is read, e.g., from the memory unit by the processing unit of the piece of equipment. For example, through language analysis such as parsing is performed, e.g., by the processing unit of the piece of equipment, on the resource file (e.g. in XML format) to read the input data set or the output data set in the resource file, or the data sets in the input description and the output description.

In step S230, a window handle of one of associated components corresponding to the at least one storage data set of the resource file is obtained, e.g., by the processing unit of the piece of equipment, from a GUI of the piece of equipment. Through a criterion established based on information of the data sets, it is ensured that the target window handles of the associated component in the resource file are identified correctly. For example, the API such as Find Window( ) in the Windows operating system is utilized as a filtering function to identify target window handles of the associated component. For another example, all child window handles are enumerated by use of Callback EnumChildwindows( ) to identify the target window handles.

After obtaining the window handles of the associated components in the storage data sets in step S230, for example, the back-end processing program 102 executes a data read operation or a user operation, e.g., by the processing unit of the piece of equipment, in response to a request message outputted from the gateway 12, as shown in steps S240 to S270 in FIG. 10. It should be noted that, steps S240 to S270 in FIG. 10 indicate that the method performs corresponding processing in response to different request messages. The order for performing steps 240 to S270 is not limited, meaning that steps S260 and S270 may be performed before steps S240 and S250. Either steps S240 and S250 or steps S260 and S270 are performed if the resource file only includes one storage data set.

In step S240, in response to a first request message indicative of executing a first operation on an associated component corresponding to a first window handle of the obtained at least one window handle, a first parameter template corresponding to the first window handle is selected e.g., by the processing unit of the piece of equipment. In step S250, according to the first window handle and the first parameter template, the first corresponding operation, such as a user operation, is performed by the processing unit of the piece of equipment. For example, the back-end processing program 102 is implemented as an event-driven Windows program, and accomplishes the user operation of the target window for the associated components of the output data set by use of the APIs of the window system such as functions of GetMessage( ) and PostMessage( ). For example,

### PostMessage(hwnd_{—}1311_TBitBtn_yes, WM_LBUTTONDOWN, 0, 0);

### PostMessage(hwnd_{—}1311_TBitBtn_yes, WM_LBUTTONUP, 0, 0).

The above program code represents that the component having a window handle of hwnd_{—}1311_TBitBtn_yes performs an operation of left-clicking of a mouse, i.e., equivalently by the processing unit of the piece of equipment.

In step S260, in response to a second request message indicative of executing a second operation on an associated component corresponding to a second window handle of the obtained at least one window handle, a second parameter template corresponding to the second window handle is selected, e.g., by the processing unit of the piece of equipment. In step S270, according to the second window handle and the second parameter template, the second corresponding operation, such as a data read operation, is performed, e.g., by the processing unit of the piece of equipment. For example, the back-end processing program 102 is implemented as an event-driven Windows program, and outputs a message to a particular target window for the associated components of the input data set by use of the APIs of the window system such as a function of GetMessage( ) so as to further obtain the data or message presented by the target window component. For example,

iComboBoxindex=SendMessage(hwnd_{—}1105_TComboBox, CB_GETCURSEL, 0, 0);
SendMessage(hwnd_{—}1105_TComboBox, CB_GETLBTEXT, iComboBoxindex, (LPARAM)tempstr).
The above program code represents that the component having a window handle of hwnd_{—}1105_TComboBo performs a data read operation to read a parameter and represent the returned parameter by the variable tempstr.

The templates selected in steps S240 and S260 may be different due to different API parameter fields of different window components. Table 4 shows an example of selecting different parameter templates when performing step S250.

```
TABLE 4
if (ifilter == 1)
{
  //Template ListBox
  SendMessage(hwnd_1301_Level09_TListbox, LB_SELECTSRTING,
−1, (LPARAM)cCPVAL);
}
if (ifilter == 2)
{
  //Template ComboBox_1
  SendMessage(hwnd_1301_Level09_TComboBox, WM_SETTEXT, 0,
(LPARAM)cCPVAL);
}
if (ifilter == 4)
{
  // Template ComboBox_1
  SendMessage(hwnd_1301_Level09_TComboBox, CB_SELECTSTRING,
0, (LPARAM)cCPVAL);
}
```

In Table 4, a value of “ifilter” represents a value corresponding to different values of “class type” and other parameters of window components. For example, when “ifilter” equals 1, it represents that the associated component is ListBox and a corresponding user operation is to select one of a plurality of strings. Therefore, when a message is sent to the target component by SendMessage( ), the associated parameter setting is as shown by the window handle (expressed in an alias “hwnd_{—}1301_Level09_TComboBox”) and parameters LB_SELECTSRTING, −1, (LPARAM)cCPVAL, as shown in Table 4. Further, when “ifilter”==2 in Table 4, it indicates that the target component is ComboBox, and the desired user operation is to set text. When “ifilter”==4, it indicates that the target component is ComboBox, and the desired user operation is to select one of the strings. Step S250 can be implemented accordingly. Templates of other window components such as child window Button, Check Box, Scroll Bar and Edit Control may be similarly implemented. Further, window components of different program development platforms are also different. For example, components such as buttons in Borland, Delphi and Visual C (or C++) have different parameter definitions, and different name types may be designated for distinction.

In step S230 according to one embodiment, the storage data set of an associated component described by the resource file is utilized as a criterion. The associated component is searched for by the “from-top-to-bottom” approach from a root node to the associated component to retrieve the handle of the corresponding component, e.g., by the processing unit of the piece of equipment. With reference to Table 1, FIGS. 4 and 8, when the back-end processing program 102 reads the storage data set in FIG. 1 with respect to an associated component in the resource file (as step S220), the root node is first obtained (i.e., the window handle of the application program 200) through the API such as FindWindow( ) in the operating system 30. The program parameters in the last row in FIG. 1 such as the class name, title, coordinates and size, are utilized as comparison conditions to confirm whether the corresponding program parameters obtained from the window handles of the application program 200 are matching. If so, the API such as EnumChildwindows( ) may be utilized to enumerate all the child window handles, and the components from window 1 to the next component are searched in a manner of “from-top-to-bottom” until the target window handle is identified, as shown in FIG. 8.

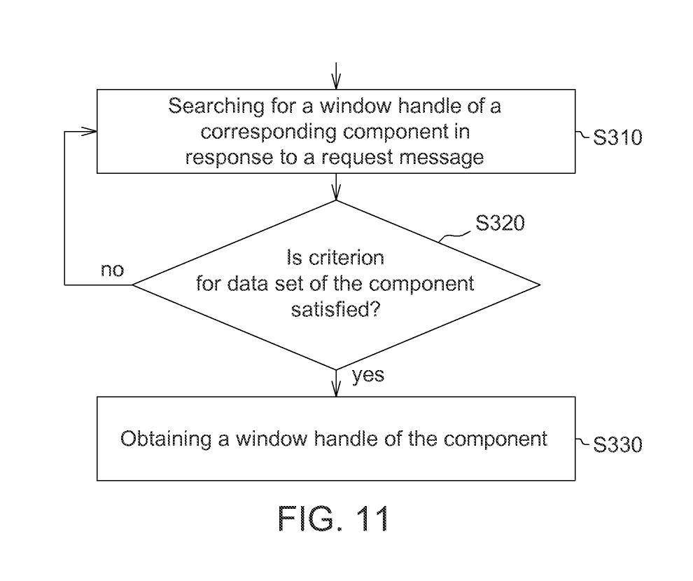

Step S230 in the above embodiment is applicable to searching enumerable components. For non-enumerable components that are dynamically generated, a similar approach may also be adopted. Searching may also be performed in loops or threads. Alternatively, as shown in FIG. 11, searching only begins when a message from the gateway 12 indicates a search for dynamically generated components. According to one embodiment, as shown in step S310, for a request message corresponding to dynamically generated components, searching for the window handles for corresponding components may also be performed as the approach for searching enumerable components, e.g., by the processing unit of the piece of equipment. In step S320, it is determined whether the window handle satisfies the criterion of the storage data set of the component, e.g., by the processing unit of the piece of equipment. When the criterion is satisfied, step S330 is performed to obtain the window handle of the component. When the criterion is not satisfied, step S310 is repeated, or the method is repeated from step S310.

Further, when performing step S230, in addition to searching by the “from-top-to-bottom” approach, during the finding of a node, the relationship between coordinates of nodes can be calculated. The calculation can be the calculation used for establishing the storage data sets in the resource file in the front-end processing (e.g., Equations 1 and 2), and such can serve as the criterion for identifying the target component.

In another embodiment, the method for operating a piece of equipment is not limited to way of generating the resource file, given that the format of the resource file is satisfied and the desired components are adequately described. In yet another embodiment, the back-end processing program 102 may be implemented as different modules as shown in FIG. 1, e.g., a processing module 1020 and a communication module 1022. The communication module 1022 supports TCP/IP, SECS and other communication protocols to provide different communication channels for extending the communication functionality of the piece of equipment 10.

In the above embodiments, a Windows operating system is taken as an example of the GUI window. Other implementations are also applicable as long as the structural resource file can be implemented for providing compatibility between the front-end processing and the back-end processing. Therefore, the foregoing embodiments are not limited to Windows systems, and the embodiments are also suitable for other window-based Linux, Unix or other embedded operating system.

In the front-end processing, the selection in step S110 may correspond to monitoring-based behavior of the piece of equipment. For example, according to interactions between a piece of equipment and an external host corresponding to Status Variable ID (SVID) defined by SECS, the selection of appropriate software components can be made to obtain resource file(s). Analysis and programming can be done according to the attributes of resource file(s) so as to facilitate the retrieval of the same components in a next activation of the application program. The operation data (e.g., pressures and temperatures) of the piece of equipment presented by the software components are transmitted to an external party by way of network communication, for example. Thus, the data can be collected and analyzed so that the external party is also enabled to control the application program 200 through the back-end processing program 102.

According to another embodiment, a computer-readable information storage medium storing a program is provided. The program is for executing the method according to the embodiment in FIG. 5 or FIG. 10. For example, the computer-readable information storage medium according to the embodiment is an optical information storage medium (e.g., CD, DVD, blue-ray DVD), or a magnetic information storage medium (e.g., floppy disk, hard disk, tape recorder and so on), or memory device (e.g., firmware, a flash memory and a USB memory device), but not limiting to the above. Further, the computer-readable information storage medium can also be code transmitted via a medium of network/transmission medium (e.g., air).

With the embodiments, a method for acquiring program parameters of components in a GUI of a piece of equipment and a method for operating a piece of equipment are provided. A structural resource file is generated according to the above method at a front end, and the structural resource file is further processed at a back end to provide an interface compatible to a factory CIM system or other interfaces. Therefore, operation parameters (data and statuses of the piece of equipment) of a closed piece of equipment are made effective and can be re-utilized so that the piece of equipment has an extended functionality supporting the factory CIM system or a communication protocol such as SECS. Since the front end of the architecture communicates with the back end through the structural resource file, application flexibilities are enhanced while also speeding up the time for program development, thereby allowing software developer or programmer to complete the collection and re-utilization of the operation data of the piece of equipment in a more efficient and reliable manner. In some embodiments, the back-end processing program facilitates an interface for monitoring of the piece of equipment.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for acquiring program parameters of a component in a graphical user interface window of a piece of equipment, comprising:
detecting a selection of the component in the graphical user interface of the piece of equipment by a processing unit of the piece of equipment;
obtaining a first data set for searching the selected component by the processing unit;
presenting the first data set along with a plurality of indications corresponding to the first data set in a window frame by a display unit of the piece of equipment to obtain an approved second data set; and
in response to an acceptance operation, storing the approved second data set to a resource file in a memory unit of the piece of equipment;
wherein the resource file includes at least one storage data set, each of the at least one storage data set is for positioning an associated component in the graphical user interface of the piece of equipment and for defining a corresponding operation to be performed on the associated component, and the at least one storage data set includes the approved second data set.

2. The method according to claim 1, wherein the at least one storage data set of the resource file includes at least one input data set, and each of the at least one input data set is for positioning an associated component and for defining a corresponding operation to be performed on the associated component as a user operation.

3. The method according to claim 2, wherein the user operation indicates a data input action, a cursor selection action or a cursor control action.

4. The method according to claim 1, wherein the at least one storage data set of the resource file includes at least one output data set, and each of the at least one output data set is for positioning an associated component and for defining a corresponding operation to be performed on the associated component as a data read operation.

5. The method according to claim 4, wherein the at least one storage data set of the resource file further includes at least one input data set, and each of the at least one input data set is for positioning an associated component and for defining a corresponding operation to be performed on the associated component as a user operation.

6. The method according to claim 4, wherein the user operation indicates a data input action, a cursor selection action or a cursor control action.

7. The method according to claim 1, wherein the first data set includes: a first window class, first relative coordinates and a first size corresponding to the selected component; and a second window class, second relative coordinates and a second size corresponding to at least one parent component of the selected component.

8. The method according to claim 7, wherein the step of obtaining the first data set for searching the selected component comprises:
k1) acquiring a plurality of first program parameters corresponding to the selected component by the processing unit, the first program parameters including a first corresponding window handle, the first window class, and first coordinates;
k2) acquiring a plurality of second program parameters corresponding to a parent component of the selected component according to the first corresponding window handle of the selected component by the processing unit, the second program parameters including a second corresponding window handle, the second window class, and second coordinates;
k3) calculating relative coordinates and a size of the selected component according to the program parameters corresponding to the selected component and the parent component by the processing unit; and
k4) by the processing unit, substituting the selected component in step (k1) by the parent component in step (k2), and repeating the method from the step (k1) to obtain a next parent component until a root node of the selected component is reached;
wherein the first data set of the selected component includes: at least the first window class, the first relative coordinates and the first size of the selected component; and the second window class, the second relative coordinates and the second size of the parent components.

9. The method according to claim 1, wherein in the step of presenting the first data set in the window frame, the indications represent whether a plurality of items in the first data set are to become content of the approved second data set.

10. The method according to claim 1, wherein the resource file is stored in Extended Markup Language (XML) based format.

11. A method for operating a piece of equipment, comprising:
providing a resource file in a memory unit of the piece of equipment, the resource file including at least one storage data set, the at least one storage data set for positioning an associated component in a graphical user interface window of the piece of equipment and for defining a corresponding operation to be performed on the associated component;
reading the resource file from the memory unit by a processing unit of the piece of equipment;
obtaining, by the processing unit, a window handle of the associated component corresponding to each of the at least one storage data set of the resource file from a graphical user interface of the piece of equipment;
in response to a request message indicative of executing an operation on an associated component corresponding to the obtained at least one window handle, selecting, by the processing unit, a parameter template corresponding to the window handle; and
performing, by the processing unit, the corresponding operation on the associated component according to the window handle and the parameter template.

12. The method according to claim 11, wherein the at least one storage data set of the resource file includes at least one input data set, and each of the at least one input data set is for positioning an associated component and for defining the corresponding operation to be performed, by the processing unit, on the associated component as a user operation.

13. The method according to claim 12, wherein the user operation indicates a data input action, a cursor selection action or a cursor control action.

14. The method according to claim 11, wherein the at least one storage data set of the resource file includes at least one output data set, and each of the at least one output data set is for positioning an associated component and for defining the corresponding operation to be performed on the associated component as a data read operation.

15. The method according to claim 14, wherein the at least one storage data set of the resource file further includes at least one input data set, and each of the at least one input data set is for positioning an associated component and for defining the corresponding operation to be performed on the associated component as a user operation.

16. The method according to claim 15, wherein the user operation indicates a data input action, a cursor selection action or a cursor control action.

17. The method according to claim 11, wherein each of the at least one storage includes a first window class, first relative coordinates and a first size corresponding to the associated component, and a second window class, second relative coordinates and a second size corresponding to at least one parent component of the associated component.

18. The method according to claim 17, wherein the step of obtaining the window handle of the associated component from each of the at least one storage data set of the resource file comprises:
g1) searching for a root node of the associated component according to the storage data set of the associated component by the processing unit;
g2) searching for a child node of the root node of the associated component according to the storage data set of the associated component by the processing unit;
g3) according to program parameters corresponding to the root node and the child node, calculating relative coordinates and a size of a component of the child node and confirm whether the program parameters are matched to data set of the associated component by the processing unit; and
g4) by the processing unit, if so, substituting the root node in step (g2) by the child node in step (g3), and repeating the method from the step (g2) to obtain a next child node until the associated component is found and the storage data set of the associated component are matching;
wherein the program parameters of each child node include at least a window class and coordinates of the child node.

19. The method according to claim 18, wherein the associated component is a dynamically generated component, and the method is performed by the processing unit from step (g1) with respect to the associated component when the request message for using the associated component is received.

20. The method according to claim 11, wherein in the step of selecting the parameter template corresponding to the window handle, the parameter template is selected by the processing unit according to a window class corresponding to the associated component of the window handle.

21. The method according to claim 11, wherein the resource file is provided in Extended Markup Language based format.
